(19) United States
(12) Patent Application Publication
(10) Pub. No.: US 2002/0127997 A1
(43) Pub. Date: Sep. 12, 2002

(54) Method for generation and transmission of messages in a mobile telecommunication network

(76) Inventors: Paul Karlstedt, Espoo (FI); Tommi Lehtinen, Espoo (FI)

Correspondence Address: ALTERA LAW GROUP, LLC, 6500 CITY WEST PARKWAY, SUITE 100, MINNEAPOLIS, MN, 55344, US

(21) Appl. No.: 09/893,028

(22) Filed: Jun. 27, 2001

Related U.S. Application Data
(63) Continuation of application No. PCT/EP99/08054, filed on Oct. 25, 1999.

(30) Foreign Application Priority Data
Dec. 30, 1998 (EP) PCT/EP98/08513

(51) Int. Cl. H04M 11/10

(52) U.S. Cl. 455/412; 455/413; 455/456; 455/466

(57) ABSTRACT

The present invention proposes a method for generation and transmission of messages in a mobile telecommunication network, comprising the steps of monitoring the location of a mobile subscriber terminal within the mobile telecommunications network using location information available for said network; comparing the monitored location with a predetermined location within said network; judging whether the monitored location corresponds to said predetermined location, and if the result of judging is positive, sending a predetermined message from said network. Also, the present invention proposes an accordingly adapted telecommunication system as well as an accordingly adapted telecommunication network element.

### FIELD OF THE INVENTION

The present invention concerns a method for generation and transmission of messages in a mobile telecommunication network, in which network communication is for example effected according to the GSM standard.

### BACKGROUND OF THE INVENTION

In recent years, mobile telecommunication networks have widely spread and the number of subscribers thereto is still continuously increasing.

Such mobile telecommunication networks are operated according to a common standard of communication, like for example the GSM standard. As regards the network architecture, such networks generally consist of a mobile access network of base transceiver stations covering a given area also known as cells, and a mobile switching network. A mobile subscriber terminal or mobile station MS, respectively, roaming within the network is able to establish a communication link with another mobile station within the network or with a subscriber to the public switched telecommunication network (hereinafter PSTN network) via an interface between the mobile network and the PSTN network.

With the continuously increasing number of subscribers to the mobile telecommunication network, the traffic load for the network is correspondingly increasing. In particular, it can be observed that there exist peak traffic load values in the network at specific times.

For example, in the evening (rush hour), when the majority of people finish work and are on the way home, people having a mobile phone, i.e. subscribers to the mobile telecommunication network, increasingly tend to make use of their mobile phone. This increases the traffic load in the network during those evening rush hours.

Among such mobile phone calls, there may be calls during which people make an appointment for the evening, call different friends, or the like. However, there are also a large number of such calls, which are established day by day with the same subscriber counterpart (e.g. at the PSTN network side) and which may have substantially the same contents each day. For example, a husband returning home from work in the evening will give his wife at home a phone call every day informing her that she may prepare dinner. Such a call has substantially invariably the same content each day, like for example “I'm on my way home darling. Please prepare the dinner.”

Apparently, this practice of the mobile subscribers creates a substantial peak load in the mobile access network at specific times of the day. In order to satisfy all subscribers, the operator of the mobile network would have to provide for additional traffic capacity of the network, which would lead to increasing costs for operating the network and in turn to an increase in the costs for the subscribers.

Also, during rush hours, it is sometimes difficult to get a telephone call (from one's mobile terminal) established to a taxi operator, which causes some discomfort to a user of a mobile phone needing a taxi and who does not want to wait too long for a taxi to be called and to arrive. Also, even after having successfully called a taxi by phone, as it is typically done, it is usually hard to estimate how long it takes for the called taxi to arrive, particularly during rush hours when streets are frequently blocked due to traffic jams in the roads. This is all the more awkward, in case the taxi is ordered from a place (e.g. inside a building) from where it is not possible to detect the arrival of the taxi. Thus, either the taxi (i.e. taxi driver) or the passenger(s) having called the taxi have to wait longer than necessary at the pick up location, thereby causing a discomfort either to the passenger(s) or clients of the taxi driver or to the taxi driver himself.

### SUMMARY OF THE INVENTION

It is therefore an object of the present invention to provide a method for generation and transmission of messages in a mobile telecommunication network which reduces the peak traffic load in the mobile access network, while also improving value added services available in a telecommunication network.

This object is achieved by a method for generation and transmission of messages in a mobile telecommunication network, comprising the steps of monitoring the location of a mobile subscriber terminal within the mobile telecommunications network using location information available for said network; comparing the monitored location with a predetermined location within said network; judging, whether the monitored location corresponds to said predetermined location, and if the result of judging is positive, sending a predetermined message from said network.

Also, according to the present invention this object is achieved by an accordingly adapted telecommunication system.

Still further, according to the present invention this object is achieved by an accordingly adapted telecommunication network element.

Advantageous further developments of the present invention are defined in the dependent claims.

Accordingly, by automatically initiating a generation and transmission of a message from a mobile network dependent on the location of a mobile subscriber terminal, the peak traffic load for the mobile access network at specific times can be reduced. Namely, it can safely be assumed that the mobile subscribers move in different directions for different distances, and consequently require different times until they are close to a respective predetermined location like for example their proper home. Thus, transmissions of messages which—without the present invention being implemented—were effected at substantially the same time, according to the present invention, are now established at different times, when the respective subscriber terminal reaches a respective predetermined location (group of cells) within the network. This leads to a distribution of the peak traffic load occurring in the mobile network over a certain period of time, thereby reducing and/or averaging the traffic load.

Accordingly, no additional traffic capacities for the mobile network need to be provided for in order to cope with such peak traffic loads. Stated in other words, no additional radio resource communications are used, since a switching center as a part of a mobile network can send the message dependent on the detection of the predetermined location information.

Furthermore, the proposed method enables the user of the mobile phone that he has not to remember to initiate the phone call on his own motion, thereby increasing the comfort for the user. In particular, when the user is driving his car, this also contributes to an increased security in road traffic.

Still further, by means of the present invention, improvements in value added service available via the telecommunication network can be realized. Particularly, for example at least some features of value added services such as features of a taxi operation center or features of an emergency doctor calling center can be automated and/or time optimized by using location information about mobile terminals, thereby enabling the notification of arrival of the taxi/emergency doctor (i.e. the taxi's/doctor's mobile terminal) at the calling terminal's side.

### BRIEF DESCRIPTION OF THE DRAWINGS

The present invention is described hereinafter in greater detail with reference to the drawings, in which:

FIG. 1 schematically shows a mobile telecommunication network with mobile subscriber terminals moving for example towards the subscribers' home places; and

FIG. 2 represents a flow chart explaining the method according to the present invention.

FIG. 3 shows a signaling scenario and flowchart of the present invention when being implemented in a taxi service as an example of a value added service available via the telecommunication network.

### DETAILED DESCRIPTION OF EMBODIMENTS OF THE INVENTION

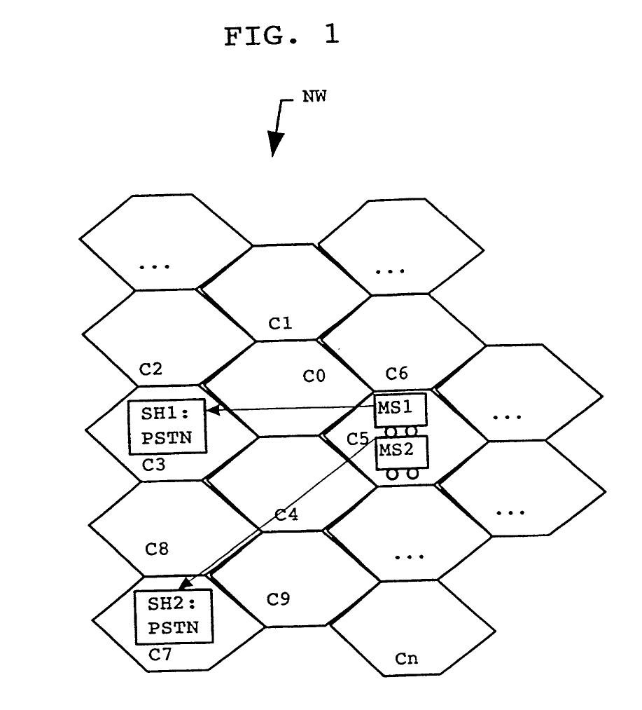

FIG. 1 shows schematically a mobile telecommunication network NW with two mobile subscriber terminals MS1, MS2 moving towards the respective subscriber's home place SH1, SH2. The mobile telecommunication network NW is illustrated as a network which consists of a plurality of cells C0, C1, . . . , C9, . . . , Cn. Each cell corresponds to a respective base station BS (not shown) present in the subject cell and is defined by the radio coverage area of the base station. In the illustrated situation, both mobile subscriber terminals MS1, MS2 of respective subscribers to the mobile telecommunication network NW are currently present in cell number C5 and (as indicated by the arrows) are moving in direction of the respective subscriber's home SH1, SH2. The subscribers homes are illustrated as being located in cell number C3, C7, respectively. The subscribers homes are each assumed to have a terminal of the public switched telephone network SH1:PSTN, SH2:PSTN.

Thus, in case both subscribers finish work at substantially the same time and their respective offices are assumed to be both located in cell number C5, without the present invention being implemented, both subscribers would initiate a call at substantially the same time.

However, with the present invention being implemented, such a call is initiated automatically upon judging that the respective subscriber MS1, MS2 has reached a group of cells comprising for example at least cells C0, C2, C3, C4, C8 (and some others “further on the left” (not shown)), and comprising at least C7, C8, C9 (and some others “further surrounding C7 on the left, bottom and right” (not shown)), respectively, which are close to his home.

Hence, assuming that e.g. in rush hours all subscribers can move only with substantially the same velocity, the time of initiating the respective call (and/or message transmission) is determined by the time, at which the respective subscriber reaches the group of cells in which his home is located. This, in turn, depends on the respective distance of the subscriber's home to his office.

In the illustrated example, the distance between MS1 in cell C5 to the group of cells (C0, C2, C3, C4, . . . ) in which SH1 is located can be expressed as “one cell”, whereas the distance between MS2 in C5 to the group of cells (C7, C8, C9, . . . ) in which SH2 is located can be expressed as “two cells”. Consequently, a call and/or message transmission from the network to SH2:PSTN will be initiated after a message transmission from the network to SH1:PSTN has been initiated, and the transmission of respective messages takes place at different times.

Thus, the initiation of the respective calls does no longer take place at substantially the same time, so that the peak traffic amount is reduced. Stated in other words, the overall traffic amount is distributed over time, dependent on the location of a respective mobile subscriber terminal.

The situation depicted in FIG. 1 has, for purposes of explanatory simplification, been limited to two subscribers only and assumed that calls would be initiated by both subscribers at “substantially the same time” (without the invention being implemented). In connection with two subscribers only, this assumption is rather “blue-eyed” as regards its practical occurrence. However, in practice, a large number of several hundreds or even thousands of subscribers is present within the cell, and from a statistical evaluation of all the subscribers behavior, it can safely be assumed that numerous calls are established at “substantially the same time” within the network, so that the above simplified description is well applicable for explaining the principle of the present invention.

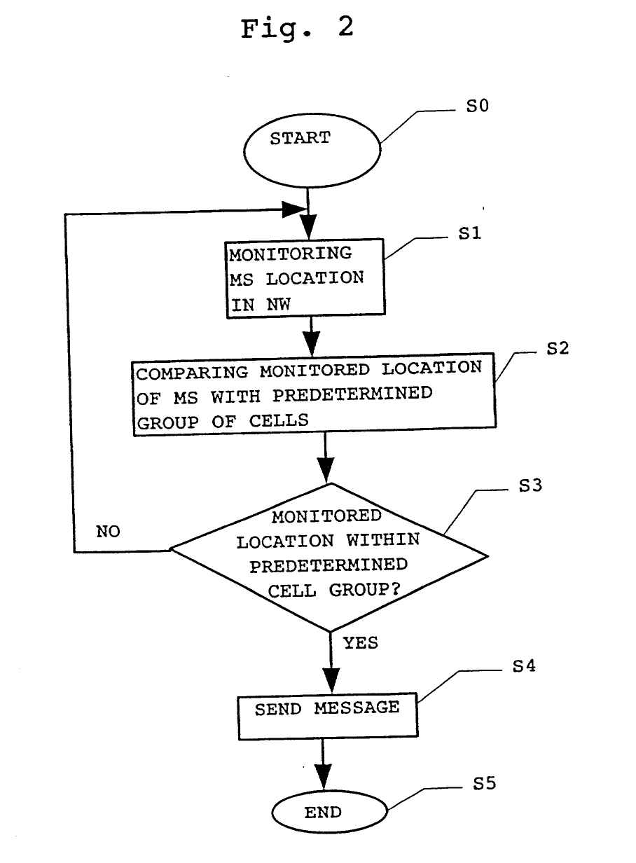

FIG. 2 shows a flow chart explaining the method according to the present invention in greater detail in terms of the respective processing steps performed.

The present invention is implemented as a subscriber service or value added service, respectively. The method is initiated upon its activation in step S0. Subsequently, the location of a subject mobile subscriber terminal MS1, MS2 for which the method is activated, is monitored in step S1. In a following step S2, the monitored location of the subject mobile station MS is compared with a predetermined group of cells, corresponding to (e.g. surrounding) a predetermined location like for example the subscriber's home. Then, in a step S3, it is judged whether the monitored location corresponds to (i.e. is within) the predetermined group of cells. Stated in other words, it is judged whether a subject mobile station MS1, MS2 has reached the correspondingly predetermined group of cells, in which group of cells for example the respective subscriber's home SH1, SH2 is located.

If the result of judgment is negative (NO in step S3), the process loops back to step S1 and monitoring the location of the respective mobile station MS in the network NW is continued.

If, however, the result of judgment is positive (YES in step S3), the process proceeds to step S4. In step S4, the generation and sending and/or transmission of a message from the network is instructed. Then a (predetermined) message is generated and transmitted by the network (i.e. by a network element like for example a network controller) for the respective mobile station MS1, MS2 to a predetermined terminal present within the respective predetermined group of cells, like for example the respective subscriber's PSTN telephone terminal SH1:PSTN, SH2:PSTN at his respective home place.

After transmission of the message, the flow reaches step S5 and the process is terminated.

In the foregoing example, the description has focused on an example, in which said predetermined group of cells comprises those cells of the network NW, which surround the cell in which there is the home of the subscriber SH1/SH2, and the cell in which there is the home of the subscriber SH1/SH2, to which subscriber the mobile MS1/MS2 and said predetermined SH1:PSTN/SH2:PSTN subscriber terminals are assigned.

However, the method may be adapted so that any group of cells of the network may be chosen as the predetermined group of cells, and the message may be transmitted to any predetermined subscriber within the predetermined group of cells. For example, a message may be transmitted to the subscribers fitness center to inform a receptionist of his soon arrival.

Furthermore, the transmitted predetermined message may be a predetermined voice message like for example one for informing one's wife to prepare dinner.

Nevertheless, according to a modification of the present invention, the method may be adapted such that the transmitted predetermined message is a data message. For example, such a data message may be a SMS (Short Message Service) message.

Also, in such a case, the data message may contain control data for remotely controlling equipment assigned to the predetermined subscriber terminal to which the message is transmitted. For example, the data message may contain control data for controlling the heating/air condition or sauna, alarm systems, the opening of the garage etc. at the subscriber's home. In a further modification, the data message may contain instructions for a transmission of data monitored at equipment assigned to said predetermined subscriber terminal, to said mobile subscriber terminal. Such monitored data to be transmitted to said mobile station MS may, for example, be the temperature in the subscribers home or some other data.

In particular, the monitoring of the location of a mobile subscriber terminal within the network can easily be effected by repeatedly retrieving data corresponding to the location of said mobile subscriber terminal MS, from a home location register in which a record of the location of each subscriber terminal present within the range of the associated mobile services switching center is kept.

Moreover, it is conceivable that a mobile subscriber is frequently moving during a day and for example frequently crosses/enters the above mentioned predetermined group of cells. In order to prevent that in such situations the predetermined message is generated and transmitted frequently by the network without actual necessity therefor, the method may be adapted to enable the generation and transmission of said predetermined message only, if additionally a predetermined time condition is met. This means that the message is generated and transmitted only, if the mobile station is present within the predetermined group of cells during a predetermined time range, like for example the evening rush hour. In such a modification, step S3 in FIG. 2 would have to be modified accordingly in that also such a timing condition is checked.

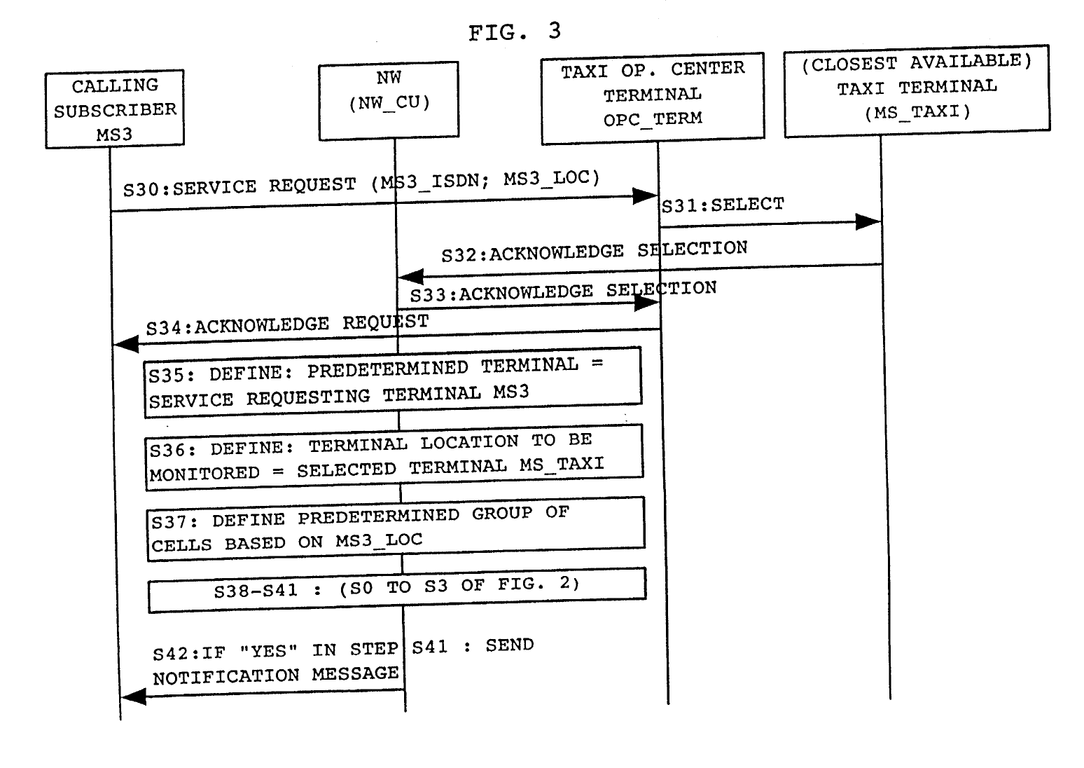

With reference to FIG. 3, this figure illustrates an example of the present invention being applied to a value added service such as an automated taxi service. However, as previously mentioned, the same principles can be applied to other services such as for example an automated emergency doctor calling service.

In FIG. 3, in the horizontal direction the terminals/entities involved when carrying out the present invention in combination with exchanged signaling messages there between are depicted. In the vertical direction, the signaling over time and sequence of method steps is illustrated.

A calling subscriber as a subscriber requesting a value added service such as calling a taxi via an (automated) taxi service is denoted by his terminal MS3. The network NW, more precisely, a network control unit adapted for carrying out the present method is denoted by NW_CU. A taxi operation center is represented by its terminal OPC_TERM, and a respective taxi of a plurality of taxis being run by the taxi operator is exemplified in FIG. 3 by referring only to a closest one and its terminal, which is available, MS_TAXI. (Note that the expression “closest” refers to the initial distance to the calling subscriber's terminal upon request of the service).

In step S30, a calling subscriber issues a service request via the network NW and/or the network control unit NW_CU to the terminal of the taxi operation center. This request represents an order for a taxi to be sent to the calling subscriber's location. The request (order) is for example suitably to be sent by using a SMS service (Short Message Service). Nevertheless, other, similar methods are also possible and do not influence the present invention. It is to be noted that such a request should at least contain an identification of the calling terminal such as its terminal telephone number denoted by MS3_ISDN and an information on its location MS3_LOC. Additionally, the request may also contain an information on the desired arriving time for a called taxi and/or the number of passengers to be transported. (Also, the request could be forwarded via a normal voice phone call and the data could be entered manually by an employee of the taxi operator at the taxi operation center side.)

As regards the location of the calling terminal, several cases can be distinguished. Firstly, a case in which the calling terminal MS3 is a mobile terminal. Then, the location of the terminal can be retrieved (by the network control unit NW_CU) from the home location register/visitor location register, where a record of the current position/location of the subscribers terminal is kept. Also, the calling terminal has a knowledge of its position within the network from the information transmitted on the BCCH channel of the base station the terminal is currently communicating with. As a result, a base station and corresponding cell and/or group of cells corresponding to the location of the calling subscriber can be found and defined for the purposes of the present invention. Secondly, a case is conceivable, in which the calling subscriber is a “fixed” subscriber of, e.g. the PSTN network. Then, the location of the subscriber can be defined by reference to the subscriber's telephone number. For example, in rural areas, the number prefix for the local area (village) could be sufficient, while in urban areas, reference could and should additionally be made to a part of the number itself, which defines a city district. The thus obtained location information of a calling PSTN subscriber MS3 is then mapped to the cell structure of the mobile telecommunication network present in that area/city district, and thus, a cell or group of cells corresponding to the location of the calling subscriber can be defined. Thirdly, the location information may be the express indication of the address, which will than have to be mapped, as in the second case, to the cell structure of the network.

Note that in case one and two above, since the location accuracy for the purposes of the present invention could be deemed to be sufficient, but presumably not for the taxi driver who has to find the exact location where he is asked to pick up his passengers, the service request message could advantageously be supplemented by an address message part in order to inform the taxi driver of the exact address where he is requested to pick up his passengers.

Upon receipt of the request at the taxi operation center terminal OPC_TERM, the taxi operation center selects the closest available taxi with regard to the location (determined by the network control unit NW_CU) of the calling subscriber MS3 and informs the selected taxi represented by its taxi terminal MS_TAXI of the fact that it is being selected, by a select message (step S31).

Stated in other words, by this selection, the taxi operator sends the closest available, i.e. suitable, taxi to the requesting subscriber and the requested location. Such methods for selection of the closest available taxi are known from prior art and are not explained here as they are not critical for the present invention. If the location information defining the calling terminal MS3 can accurately enough be determined, these information can be forwarded to the taxi's terminal and the taxi driver. Thus, under optimal conditions, this method could be used to handle most or all calls for taxi, thereby enabling the provision of an automated taxi operation center.

The terminal at the selected taxi's side MS_TAXI, in step S32, acknowledges that it has been selected to the network control unit NW CU. This acknowledgment is forwarded further to the taxi operation center, i.e. the taxi operation center terminal OPC_TERM, step S33.

If desired, the acknowledge message can be forwarded still further from the taxi operation center terminal OPC_TERM to the calling subscriber terminal MS3, see step S34, thereby informing the calling/requesting subscriber, for example, that his request has been received and is being processed, possibly supplemented by an indication of the estimated time of arrival of the taxi.

At this stage of the processing, the network control unit has the necessary information for carrying out the (basic) method described herein before. That is, then, in step S35, the predetermined terminal, to which a message is conditionally to be sent, is defined as the terminal requesting for the service (i.e. calling the taxi) MS3. The terminal is defined and identified by its MSISDN, i.e. MS3_ISDN.

In step S36, the terminal location to be monitored is defined to be the location of the selected terminal, i.e. the terminal of the selected, closest available taxi MS_TAXI. This terminal MS_TAXI is moving via the mobile telecommunication network, and, after a certain time of movement, reaches a predetermined position and/or predetermined group of cells corresponding to the position of the calling subscriber's terminal location.

In step S37, the predetermined group of cells is defined based on the information on the location of the service requesting (taxi calling) terminal MS3_LOC.

With these information being available to the network control unit carrying out the method of the present invention, steps S38 to S41 are carried out which correspond to steps S0 to S3 explained further above in connection with FIG. 2, so that these steps are not explained here in detail again.

If the judgment in step S41 yields “YES”, then a notification message is sent in step S42 to the calling terminal MS3, thereby informing the calling subscriber that the requested taxi is about to arrive at the pickup location, i.e. at the location/position of the calling user and his terminal MS3.

Thus, as has been described in connection with the implementation of the present invention in connection with FIG. 3, a value added service such as a taxi service is described, in which a subscriber calling a taxi sends a request in form of a voice call, SMS, etc. to a taxi operation center, in which request the identity and the location of the subscriber is indicated or on the basis of which these information can be determined. The taxi operation center then selects the most suitable (i.e. closest available) taxi based on the current locations of the taxis at the time of receipt of the request. When the taxi is about to arrive at the pickup location indicated based on the location of the calling terminal (an estimate or triggered by the taxi coming to a predetermined distance from the pick up location, e.g. entering a group of cells in the coverage area of which the calling subscriber terminal is present), a notification is sent to the calling subscriber's terminal, e.g. in form of a voice call, a SMS as a kind of a data message, or the like.

Furthermore, it should be noted that although in the foregoing description, the present invention has been described with a focus to cell information as a location information, this is not limiting for the proposed invention. Stated in other words, a location of a mobile subscriber terminal within the telecommunication network may be determined based on using location information available for said network. Thus, such location information can be cell information or location area information or even some other location information.

Accordingly, as has been described herein before, the present invention proposes a method for generation and transmission of messages in a mobile telecommunication network, comprising the steps of monitoring S1; S39 the location of a mobile subscriber terminal MS1, MS2; MS_TAXI within the mobile telecommunications network NW, CO, Cn using location information available for said network; comparing S2; S40 the monitored location C5 with a predetermined location C0, C2, C3, C4; C7, C8, C9; MS3_LOC within said network; judging S3, S41, whether the monitored location corresponds to said predetermined location, and if the result of judging is positive, sending S4; S42 a predetermined message from said network. Also, the present invention proposes an accordingly adapted telecommunication system as well as an accordingly adapted telecommunication network element.

It should be understood that the above description and accompanying figures are merely intended to illustrate the present invention by way of example only. The preferred embodiments of the present invention may thus vary within the scope of the attached claims.

1. A method for generation and transmission of messages in a mobile telecommunication network,
comprising the steps of
monitoring (S1; S39) the location of a mobile subscriber terminal (MS1, MS2; MS_TAXI) within the mobile telecommunications network (NW, C0, . . . , Cn) using location information available for said network;
comparing (S2; S40) the monitored location (C5) with a predetermined location (C0, C2, C3, C4; C7, C8, C9; MS3_LOC) within said network;
judging (S3, S41), whether the monitored location corresponds to said predetermined location, and
if the result of judging is positive, sending
(S4; S42) a predetermined message from said network.

2. A method according to claim 1, wherein said message is sent to a predetermined subscriber terminal (SH1:PSTN, SH2:PSTN; MS3, MS3_ISDN).

3. A method according to any of claims 1 to 2, wherein said message is a voice message.

4. A method according to any of claims 1 to 2, wherein said message is a data message.

5. A message according to claim 4, wherein said data message is a SMS message.

6. A method according to claim 4, wherein said data message contains data for remotely controlling equipment assigned to said predetermined subscriber terminal (PSTN).

7. A method according to claim 4, wherein said data message contains instructions for transmission of data monitored at equipment assigned to said predetermined subscriber terminal (PSTN), to said mobile subscriber terminal (MS).

8. A method according to claim 1, wherein said monitoring (S1) is effected by repeatedly retrieving data corresponding to the location of said mobile subscriber terminal (MS), from a home location register in which a record of the location of each subscriber terminal present within the range of an associated mobile services switching center is kept.

9. A method according to claim 1, wherein said predetermined message is transmitted only within a predetermined time range.

10. A method according to claim 2, further comprising a step of defining (S35) said predetermined terminal (MS3) as a terminal which has issued a request for a value added service.

11. A method according to claim 10, wherein said request contains at least an identification (MS3_ISDN) of said predetermined terminal (MS3) and a location information (MS3_LOC) for said predetermined terminal.

12. A method according to claim 11, further comprising a step of defining (S37) said predetermined location based on said location information (MS3_LOC) for said predetermined terminal (MS3).

13. A method according to claim 10, wherein said message is a voice message.

14. A method according to claim 10, wherein said message is a data message.

15. A message according to claim 14, wherein said data message is a SMS message.

16. A method according to claim 10, wherein said monitoring (S1; S39) is effected by repeatedly retrieving data corresponding to the location of said mobile subscriber terminal (MS), from a home location register in which a record of the location of each subscriber terminal present within the range of an associated mobile services switching center is kept.

17. A method according to claim 1, wherein said location information available for said network is cell information.

18. A method according to claim 1, wherein said location information available for said network is location area information.

19. A telecommunication system adapted to carry out the method according to any of the preceding claims 1 to 18.

20. A telecommunication network element adapted to carry out the method according to any of the preceding claims 1 to 18.
